(19) United States
(12) Patent Application Publication
(10) Pub. No.: US 2008/0283399 A1
(43) Pub. Date: Nov. 20, 2008

(54) POTENTIOMETRIC PROCESS ANALYTIC SENSOR WITH ISOLATED TEMPERATURE SENSOR

(75) Inventors: Chang-Dong Feng, Long Beach, CA (US); Barry W. Benton, Orange, CA (US)

Correspondence Address: WESTMAN CHAMPLIN & KELLY, P.A., SUITE 1400, 900 SECOND AVENUE SOUTH, MINNEAPOLIS, MN, 55402-3244, US

(73) Assignee: Rosemount Analytical Inc., Irvine, CA (US)

(21) Appl. No.: 12/120,619

(22) Filed: May 14, 2008

Related U.S. Application Data
(60) Provisional application No. 60/930,723, filed on May 18, 2007.

(51) Int. Cl. G01N 27/26

(52) U.S. Cl. 204/408

(57) ABSTRACT

A sensor for analyzing a liquid sample is provided. The sensor includes a sensor body defining a chamber therein. A sensing cell is disposed within the chamber and is adapted to contact the sample solution. The sensing cell has a sensing cell fill solution therein, and a sensing electrode disposed within the sensing cell fill solution. A reference fill solution is disposed within the sensor body. A reference junction is arranged to contact the reference fill solution and the sample solution. A temperature sensitive device is disposed within the body and is configured to provide a temperature sensitive device output. A reference electrode is disposed within the sensor body in contact with the reference fill solution. A solution ground electrode is disposed within the sensor body and spaced from the reference electrode.

### CROSS-REFERENCE TO RELATED APPLICATION

The present application is based on and claims the benefit of U.S. provisional patent application Ser. No. 60/930,723, filed May 18, 2007, the content of which is hereby incorporated by reference in its entirety.

### BACKGROUND

Electrochemical cells form the basis of a variety of analytical sensors. Electrochemical cells generally have two or more electrodes of the cell and are coupled to an analyzer that measures an electrical characteristic of the cell in order to infer a property of a sample within, or otherwise coupled to, the cell. Many electrochemical cells include a measurement electrode and a reference electrode. The reference electrode is usually located within a chamber that houses a reference electrode fill solution. A junction, of some sort, allows electrochemical interaction between a sample solution and the fill solution. Electrochemical cells can be used for oxidation/reduction potential (ORP) sensors, pH sensors, or other suitable sensors.

One type of electrochemical sensor is known as potentiometric sensor. A potentiometric sensor is an electrochemical sensor that has a voltage output. The potentiometric sensor consists of two electrochemical cells, one for sensing, and the other for reference. A typical potentiometric sensor is the combination pH sensor with a pH glass electrode as the sensing cell and a silver/silver chloride (Ag/AgCl) electrode as the reference cell.

It is known that many of the electrochemical interactions that affect the potentiometric sensor vary with temperature. Accordingly, electrochemical sensors, including potentiometric sensors, are sometimes utilized in combination with a temperature sensor such that the temperature of the fill solution, sample solution, or the combination thereof, can be used to compensate, or otherwise adjust the reading of the potentiometric sensor. Generally, in order to ensure that the response of the temperature sensor is suitably quick, the temperature sensor will be placed directly inside the fill solution of either the sensing cell or the reference cell.

Providing a process analytic potentiometric sensor that includes a temperature sensor, but is more robust, would allow process analytic temperature-compensated potentiometric sensors to last longer.

### SUMMARY

A sensor for analyzing a liquid sample is provided. The sensor includes a sensor body defining a chamber therein. A sensing cell is disposed within the chamber and is adapted to contact the sample solution. The sensing cell has a sensing cell fill solution therein, and a sensing electrode disposed within the sensing cell fill solution. A reference fill solution is disposed within the sensor body. A reference junction is arranged to contact the reference fill solution and the sample solution. A temperature sensitive device is disposed within the body and is configured to provide a temperature sensitive device output. A reference electrode is disposed within the sensor body in contact with the reference fill solution. A solution ground electrode is disposed within the sensor body and spaced from the reference electrode.

### BRIEF DESCRIPTION OF THE DRAWINGS

FIG. 1 is a diagrammatic view of a potentiometric process analytic system in accordance with the prior art.

FIG. 2 is a diagrammatic view of a process analytic sensor in accordance with an embodiment of the present invention.

FIG. 3 is a bottom plan view of a potentiometric process analytic sensor in accordance with an embodiment of the present invention.

FIG. 4 is a diagrammatic view of a potentiometric process analytic system in accordance with an embodiment of the present invention.

### DETAILED DESCRIPTION OF THE PREFERRED EMBODIMENTS

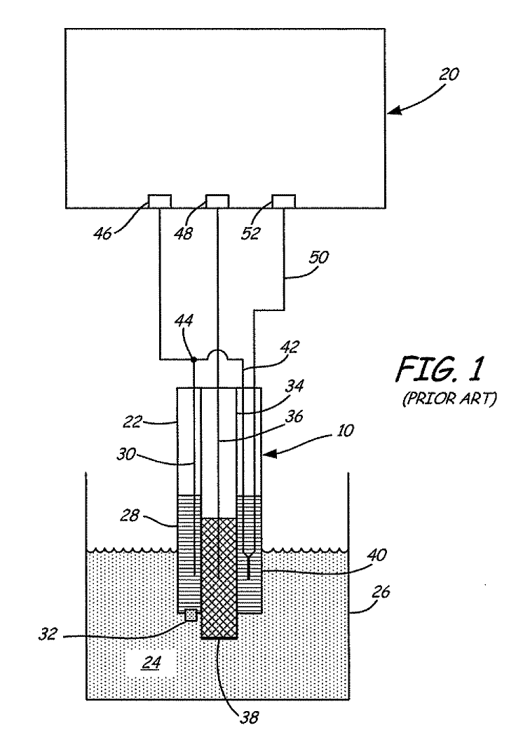

FIG. 1 is a diagrammatic view of a potentiometric process analytic system in accordance with the prior art. As illustrated in FIG. 1, a potentiometric process analytic sensor 10 is coupled to a process analyzer 20. Process analytic sensor 10 includes a body 22 that is disposed within sample solution 24 inside sample container 26. While sample container 26 is illustrated as a simple container, such simplicity is for illustration purposes only and container 26 may be pipe, tank, or any suitable vessel that carries a sample solution for which process analytic information is desired. A reference fill solution 28 is disposed within body 22 and is in fluidic contact with reference electrode 30 and reference junction 32. Sensing cell 34 is also disposed within body 22 and includes sensing lead 36 in fluidic contact with solution 38. An example of reference fill solution 28 can be 3M KCl, or any other solution with a determined concentration of chloride. An example of sensing cell fill solution 34 can be a mixture of KCl, or any other solution with a determined concentration of chloride and a pH buffer solution. Additionally, reference junction 32 is illustrated simply as a small block, but can take any suitable form that allows suitable electrical interaction between the sample solution 24 and reference solution 28. Those skilled in the art will recognize that various potentiometric sensor arrangements can be constructed using a variety of different sensing electrodes and fill solutions.

Sensor 10 also includes a temperature sensor 40 disposed within reference fill solution 28. Providing a temperature sensor in reference fill solution 28 or within the fill solution of the sensing cell 34 is known. Moreover, FIG. 1 illustrates the prior art practice of providing a low-impedance coupling, such as a direct connection, between one lead 42 of temperature sensor 40 and reference electrode 30, which connection is illustrated diagrammatically at node 44. This node is then coupled to circuit ground port 46 on analyzer 20. Sensing electrode 36 is coupled to sensing port 48 on analyzer 20, while lead 50 of temperature sensor 40 is coupled to the temperature input 52 on analyzer 20. In this way, analyzer 20 can sense the potentiometric sensor value via the connection across terminals 46 and 48. Additionally, the temperature can be sensed, by analyzer 20, across terminals 46 and 52. One problem with this arrangement is that temperature sensor 40 must be carefully encapsulated to isolate it from the potentiometric sensor. If the isolation is compromised, the potentiometric sensor, such as the pH sensor reading, will be erroneous.

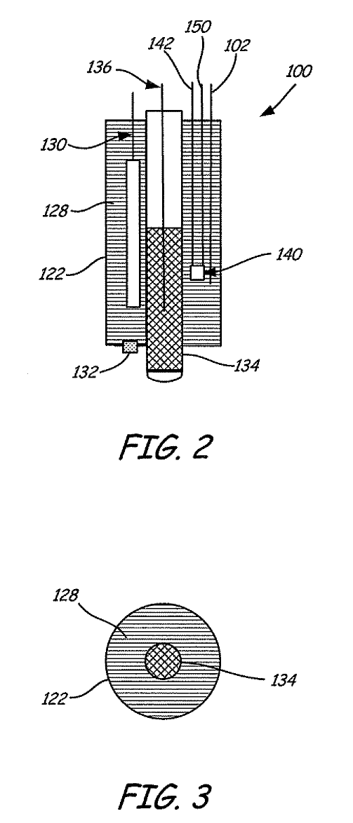

FIG. 2 is a diagrammatic view of a potentiometric process analytic sensor in accordance with an embodiment of the present invention. Sensor 100 bears some similarities to sensor 10 (described with respect to FIG. 1) and like components are numbered similarly. Notably, temperature sensor 140 is disposed within reference fill solution 128 and includes a pair of temperature sensor leads 142, 150. Additionally, reference junction 132 is still illustrated diagrammatically as a small box disposed at the base of sensor body 122, but can be any suitable arrangement. However, sensor 100 includes an additional electrode as solution ground electrode 102 disposed within reference fill solution 128.

FIG. 3 illustrates that the potentiometric process analytic sensor is preferably shaped cylindrically with the sensing cell 134 disposed concentrically within sensor body 122.

Referring back to FIG. 2, temperature sensitive device 140 can be a resistance temperature device (RTD), a thermocouple, a thermistor, or any other suitable temperature sensing arrangement. Reference electrode 130 is not coupled to either of leads 142 or 150 of temperature sensor 140. Additionally, temperature sensitive device 140 is still preferably electrically isolated from the reference fill solution and the sensing cell fill solution. Preferably, such isolation is accomplished using encapsulation in such a way that allows substantial thermal contact between the fill solution and the temperature sensitive device 140.

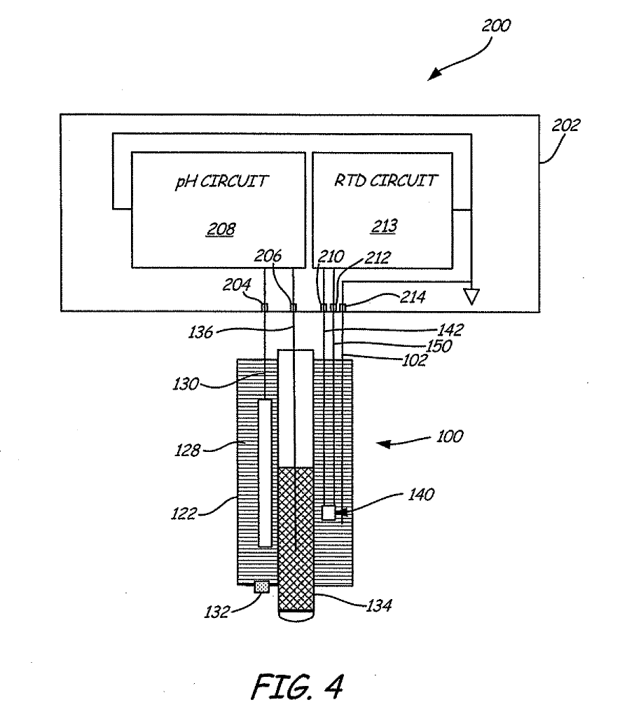

FIG. 4 is a diagrammatic view of a potentiometric process analytic system in accordance with an embodiment of the present invention. System 200 includes analyzer 202 coupled to sensor 100. Reference electrode 130 of sensor 100 is coupled to reference electrode input 204 of analyzer 202. Sensing electrode 136 is coupled to sensing electrode input 206 of analyzer 202. Inputs 204 and 206 are coupled to a potentiometric measurement circuit, such as pH measurement circuit 208. Sensor lead 142 of temperature sensor 140 is coupled to first temperature sensor input 210 of analyzer 202. Second temperature sensor lead 150 of temperature sensor 140 is coupled to second temperature sensor input 212 of analyzer 202. Each of inputs 210 and 212 are coupled to a temperature measurement circuit, such as RTD circuit 213.

Solution ground lead 102 is coupled to circuit common input 214 of analyzer 202, which input 214 is electrically coupled to pH measurement circuit 208 and RTD circuit 213. Accordingly, a low impedance connection between either of the temperature sensor leads and reference electrode 130 is eliminated. Solution ground lead 102, by virtue of its connection to circuit common of analyzer 202, maintains reference fill solution 128 at a ground potential. Preferably, solution ground electrode 102 is made of platinum, or other suitable stable metals, and is placed in the reference chamber in the fill solution. Further, temperature sensitive device 140 is preferably still encapsulated and is also placed in the reference chamber in the fill solution. For a dual input analyzer, such as analyzer 202, both the sensing electrode 136 and reference electrode 130 are connected to the two input terminals 206, 204, respectively. In this case, with a non-isolated circuit design, any leakage from temperature sensor 140 will not affect the potentiometric reading from pH circuit 208. It is believed that this will allow process analytic potentiometric sensors and systems in accordance with embodiments of the present invention to continue to provide usable readings even when the encapsulation of the temperature sensor begins to break down, or no longer isolates the temperature sensor from the fill solution.

Although the present invention has been described with reference to preferred embodiments, workers skilled in the art will recognize that changes may be made in form and detail without departing from the spirit and scope of the invention.

What is claimed is:

1. A potentiometric sensor for analyzing a liquid sample, the sensor comprising:
a sensor body defining a chamber therein;
a sensing cell disposed within the chamber and being adapted to contact the sample solution, the sensing cell having a sensing cell fill solution therein, and a sensing electrode disposed within the sensing cell fill solution;
a reference fill solution disposed within the sensor body;
a reference junction arranged to contact the reference fill solution and the sample solution;
a temperature sensitive device disposed within the body and configured to provide a temperature sensitive device output;
a reference electrode disposed within the sensor body in contact with the reference fill solution; and
a solution ground electrode spaced from the reference electrode, the solution ground electrode being disposed within the sensor body.

2. The sensor of claim 1, wherein the temperature sensitive device is an RTD.

3. The sensor of claim 1, wherein the sensor is potentiometric pH sensor.

4. The sensor of claim 1, wherein the sensing cell comprises a pH glass electrode.

5. The sensor of claim 1, wherein the reference electrode is constructed from silver and silver chloride (Ag/AgCl).

6. The sensor of claim 1, wherein the solution ground electrode is constructed from platinum.

7. The sensor of claim 1, wherein the temperature sensitive device is encapsulated and disposed within the reference fill solution.

8. The sensor of claim 1, wherein the temperature sensitive device is encapsulated and disposed within the sensing cell fill solution.

9. A potentiometric process analytic system for analyzing a liquid sample, the system comprising:
an analyzer having a first plurality of inputs, a second plurality of inputs, and a solution ground input, the analyzer being configured to measure a voltage across the first plurality of inputs, obtain a temperature sensitive input through the second plurality of inputs, and provide a temperature-compensated analytical output relative to a liquid sample;
a potentiometric process analytic sensor including:
a sensor body defining a chamber therein;
a sensing cell disposed within the chamber and being adapted to contact the sample solution, the sensing cell having a sensing cell fill solution therein, and a sensing electrode disposed within the sensing cell fill solution the sensing electrode being coupled to one of the first plurality of inputs;
a reference fill solution disposed within the sensor body;
a reference junction arranged to contact the reference fill solution and the sample solution;
a temperature sensitive device disposed within the body and configured to provide a temperature sensitive device output coupled to the second plurality of inputs;
a reference electrode disposed within the sensor body in contact with the reference fill solution and coupled to the another of the first plurality of input; and
a solution ground electrode spaced from the reference electrode, the solution ground electrode being disposed within the sensor body and coupled the solution ground input of the analyzer.

10. The system of claim 9, wherein the analyzer includes pH measurement circuitry operably coupled to the first plurality of inputs.

11. The system of claim 10, wherein the analyzer includes temperature measurement circuitry operably coupled to the second plurality of inputs.

12. The system of claim 9, wherein the solution ground electrode is constructed from platinum.

13. The system of claim 9, wherein the potentiometric process analytic sensor is a process pH sensor.

14. The system of claim 13, wherein the sample cell comprises a pH glass electrode.
